(19) United States
(12) Patent Application Publication
(10) Pub. No.: US 2023/0306274 A1
(43) Pub. Date: Sep. 28, 2023

(54) WEIGHTS LAYOUT TRANSFORMATION ASSISTED NESTED LOOPS OPTIMIZATION FOR AI INFERENCE

(71) Applicant: QUALCOMM Incorporated, San Diego, CA (US)

(72) Inventor: Haijun ZHAO, Beijing (CN)

(21) Appl. No.: 18/040,385

(22) PCT Filed: Sep. 15, 2020
(86) PCT No.: PCT/CN2020/115243

§ 371 Date: Feb. 2, 2023

(51) Int. Cl. G06N 3/10

(52) U.S. Cl. CPC G06N 3/10

(57) ABSTRACT

Various embodiments include methods and devices for weight layout transformation of a weight tensor. Embodiments may include, accessing a first memory to retrieve weights of the weight tensor in a transformed order that is different than an order for retrieving the weights for a calculation at a network layer of a trained machine learning model, and loading the weights to a second memory in the transformed order. Embodiments may further include retrieving the weights from the second memory in the transformed order, and reordering the weights to the order for implementing the calculation at the network layer of the trained machine learning model.

### RELATED APPLICATIONS

This application claims the benefit of priority to PCT Application No. PCT/CN2020/115243 entitled “WEIGHTS LAYOUT TRANSFORMATION ASSISTED NESTED LOOPS OPTIMIZATION FOR AI INFERENCE” filed Sep. 15, 2020, the entire contents of which are hereby incorporated by reference of all purposes.

### BACKGROUND

Various types of computing hardware, such ultra-low power processors, like a sensor digital signal processor (DSP), a modem DSP, a memory control unit (MCU), etc., use trained neural networks to generate inferences in various applications. Execution of trained neural networks by such computing hardware is costly as computing resources, such as computing power and memory space and bandwidth, are limited. Trained neural network can require costly nested loop execution that can burden the computing resources of such computing hardware.

### SUMMARY

Various aspects may include methods and apparatuses for weights layout transformation assisted nested loops optimization for artificial intelligence (AI) inference. Various aspects may include accessing a first memory to retrieve weights of the weight tensor in a transformed order that is different than an order for retrieving the weights for a calculation at a network layer of a trained machine learning model, and loading the weights to a second memory in the transformed order.

In some aspects, accessing the first memory to retrieve weights of the weight tensor in the transformed order that is different than the order for retrieving the weights for the calculation at the network layer of the trained machine learning model may include accessing the first memory to retrieve the weights according to a pattern of memory access iterating over a slowest changing dimension of the weight tensor.

In some aspects, accessing the first memory to retrieve the weights according to the pattern of memory access iterating over the slowest changing dimension of the weight tensor may include retrieving the weights according to a pattern of memory access iterating over a height dimension of the weight tensor.

In some aspects, accessing the first memory to retrieve weights of the weight tensor in the transformed order that is different than the order for retrieving the weights for the calculation at the network layer of the trained machine learning model may include accessing the first memory to retrieve weights of the weight tensor in an order specified by a first counter variable and a second counter variable of a first memory access command, in which the first counter variable and the second counter variable are configured to represent a location in the weight tensor, and in which the first counter variable and the second counter variable are transposed relative to a second memory access command having the first counter variable and the second counter variable of the network layer of the trained machine learning model.

In some aspects, loading the weights to the second memory in the transformed order may include loading the weights to the second memory in a linear layout according to a pattern of memory access iterating over a slowest changing dimension of the weight tensor.

In some aspects, loading the weights to the second memory in the linear layout may include loading the weights to the second memory as a linear array.

Some aspects may further include retrieving the weights from the second memory in the transformed order, and reordering the weights to the order for implementing the calculation at the network layer of the trained machine learning model.

In some aspects, the first memory and the second memory may be in the same memory device.

Further aspects include a computing device having a processing device configured to perform operations of any of the methods summarized above. Further aspects include a computing device having means for performing functions of any of the methods summarized above. Further aspects include a non-transitory processor-readable medium having stored thereon processor-executable instructions configured to cause a processor and other components of a computing device to perform operations of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating an example computing device suitable for implementing various embodiments.

FIGS. 2A and 2B are block diagrams illustrating an example of weight tensor transformation suitable for implementing various embodiments.

FIG. 3 is a component block and flow diagram illustrating an example trained machine learning model execution using a linear weight layout of a weight tensor suitable for implementing various embodiments.

FIG. 4 is a component block and flow diagram illustrating an example system for implementing source code of trained machine learning models configured for weight tensor transformation suitable for implementing various embodiments.

FIG. 5 is a computer code block diagram illustrating an example of computer code for source code of trained machine learning models configured for weight tensor transformation suitable for implementing various embodiments.

FIG. 6 is a process flow diagram illustrating a method for trained machine learning model execution using weight tensor transformation according to some embodiments.

FIGS. 7A and 7B are process flow diagrams illustrating methods for weight layout transformation according to some embodiments.

FIG. 8 is a process flow diagram illustrating a method for weight layout transformation according to some embodiments.

FIG. 9 is a process flow diagram illustrating a method for weight correction according to some embodiments.

FIG. 10 is a component block diagram illustrating an example mobile computing device suitable for implementing various embodiments.

FIG. 11 is a component block diagram illustrating an example mobile computing device suitable for implementing various embodiments.

FIG. 12 is a component block diagram illustrating an example server suitable for implementing various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods and computing devices implementing such methods for weights layout transformation assisted nested loops optimization for artificial intelligence (AI) inference. Various embodiments may include transforming a weight tensor to a linear format, such as a linear array, in a memory for access during execution of a trained neural network. In some embodiments, the weight transformation from a weight tensor to a linear format may be implemented through modification of source code for a trained neural network. In some embodiments, the modification of source code for a trained neural network may include a modification of a memory access pattern configured to reduce a number of iterations of a nested loop for retrieving weights for implementation of the trained neural network. In some embodiments, the memory access pattern may be configured to retrieve weights according to a slowest rate of change of values of the weights as organized in a weight tensor. Some embodiments may include correcting the weight retrieval pattern from the linear format for implementing the trained neural network to generate inferences.

The terms “computing device” and “mobile computing device” are used interchangeably herein to refer to any one or all of cellular telephones, smartphones, personal or mobile multi-media players, personal data assistants (PDA’s), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor. The term “computing device” may further refer to stationary computing devices including personal computers, desktop computers, all-in-one computers, workstations, super computers, mainframe computers, embedded computers (such as in vehicles and other larger systems), servers, multimedia computers, and game consoles.

The terms “edge processing device” and “edge processor” are used interchangeably herein to refer to processing devices that may use existing, dedicated firmware toolchains for which machine learning models need to be adapted for use with the existing, dedicated firmware toolchains to be implemented by the processing device, and that implement machine learning model processing locally on a computing device. Edge processing devices may have limited compiler capabilities, memory, and/or processing power. Edge processing devices may refer to any or all of low power processors, sensor digital signal processors, modem digital signal processors, memory control units, embedded processors, controllers, microcontrollers, etc.

Various software vendors have developed and trained machine learning models that can be implemented on computing devices developed by computing device developers. For example, trained machine learning models may include Keras, TensorFlow, TensorFlow Lite, PyTorch, Caffe, Caffe 2, MXNet, Android Neural Networks API, Snapdragon Neural Processing Engine (SNPE), etc. Such machine learning models are commonly distributed with software development kit (SDK) libraries for implementation on a computing device. General purpose processors, such as a central processing unit, may use various compilers configured to compile software developed using the machine learning model SDK libraries and execute the compiled software.

However, many edge processing devices may have limited capability to use machine learning model SDKs, and trained machine learning models may be converted to source code that may be compiled and implemented by edge processing devices. For example, trained machine learning models may be converted to source code that may be compiled and implemented by edge processing devices as described in International Patent Application No. PCT/CN2020/095790, filed on Jun. 12, 2020, the entirety of which is incorporated herein by reference for background.

The trained machine learning models source code (referred to herein as network construct source code) may be implemented using nested loops. Loops play an important role in increasing execution speed and reducing the overheads associated with execution of trained machine learning models. For example, various layers of a trained machine learning model may be implemented using nested loops to traverse tensors for input to and to execute computations of the layers. However, compilers are inefficient for nested loop optimization. Inference generation using trained machine learning models is based on nested loops using dynamic inputs, such as feature maps, and static inputs, such as weights. The order in which the nested loops are implemented and the order in which the implementations of the nested loops access the inputs can cause high rates of dynamic memory allocations and writes, which consumes memory resources, such as space, bandwidth, and electric power.

In the embodiments described herein, methods, and computing devices implementing such methods may implement a transformation of a weight tensor for a trained neural network via a memory access pattern configured to reduce a number of iterations of a nested loop for retrieving weights for implementation of the trained neural network. The transformation may be implemented using modified network construct source code (referred to herein as a weight layout transformer) configured to access the weights in the memory access pattern, which may be different from a memory access pattern of an original network construct source code. The memory access pattern may use a static memory allocation that requires fewer memory resources than multiple dynamic allocations. The memory access pattern may also be a sequential memory access that may reduce the number of writes to and read of the memory to retrieve the weights. For example, the memory access pattern may be such that each weight may be accessed sequentially, such as using a stride-1 reference pattern of a linear layout of a multi-dimensional weight tensor, such as a row-major layout. In some embodiments, the memory access pattern for the weights may be the same as a memory access pattern for the dynamic inputs.

The memory access pattern may access the weights in a transformed order different than an order that may be expected for implementing computations of the layers of the trained neural network. Implementing computations of the layers using weights received in an unexpected order may produce incorrect results of the computations. Accounting for the difference in the memory access pattern, a weight corrector may modify the order in which the weights retrieved from the memory are provided for implementing computations of the layers. The weight corrector may ensure implementing computations of the layers using the weights in an expected order.

The weight layout transformer and the weight corrector may be in the same high-level programming language, such as C, C++, Java, Pascal, COBOL, BASIC, etc., as the original network construct source code. The high-level programming language may be such that a compiler for the language may be implemented by an edge processing device, and such that a trained machine learning model may be implemented in software created using the existing, dedicated firmware toolchain of an edge processing device without needing to adapt the machine learning model SDK and the edge processing device hardware. The weight layout transformer and the weight corrector may be used in the software created using the existing, dedicated firmware toolchain of the edge processing device without using the machine learning model SDK libraries. Using the disclosed embodiments may reduce the time to market for an edge processing device able to implement a trained machine learning model. Using a high-level programming language may enable quicker and easier testing and debugging of the weight layout transformer and the weight corrector and of the software implementing the trained machine learning model generated using the weight layout transformer and the weight corrector and the existing, dedicated firmware toolchains of the edge processing devices. Further, the weight layout transformer and the weight corrector are portable for any edge processing device configured to compile and implement the programming language of the weight layout transformer and the weight corrector.

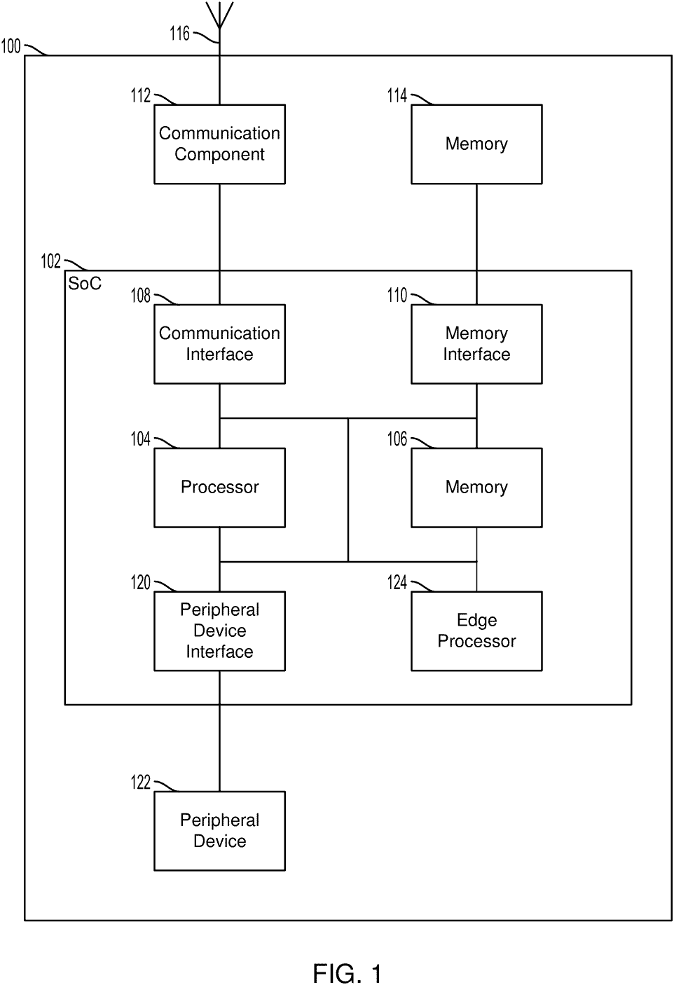

FIG. 1 illustrates a system including a computing device 100 suitable for use with various embodiments. The computing device 100 may include an SoC 102 with a processor 104, a memory 106, a communication interface 108, a memory interface 110, a peripheral device interface 120, and an edge processor 124. The computing device 100 may further include a communication component 112, such as a wired or wireless modem, a memory 114, an antenna 116 for establishing a wireless communication link, and/or a peripheral device 122. The processor 104 may include any of a variety of processing devices, for example a number of processor cores.

The term “system-on-chip” or “SoC” is used herein to refer to a set of interconnected electronic circuits typically, but not exclusively, including a processing device, a memory, and a communication interface. A processing device may include a variety of different types of processors 104 and/or processor cores, such as a general purpose processor, a central processing unit (CPU), a digital signal processor (DSP), a graphics processing unit (GPU), an accelerated processing unit (APU), a secure processing unit (SPU), a subsystem processor of specific components of the computing device, such as an image processor for a camera subsystem or a display processor for a display, an auxiliary processor, a single-core processor, a multicore processor, a controller, and/or a microcontroller. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and/or time references. Integrated circuits may be configured such that the components of the integrated circuit reside on a single piece of semiconductor material, such as silicon.

The SoC 102 may include one or more processors 104. The computing device 100 may include more than one SoC 102, thereby increasing the number of processors 104 and processor cores. The computing device 100 may also include processors 104 that are not associated with an SoC 102. Individual processors 104 may be multicore processors. The processors 104 may each be configured for specific purposes that may be the same as or different from other processors 104 of the computing device 100. One or more of the processors 104 and processor cores of the same or different configurations may be grouped together. A group of processors 104 or processor cores may be referred to as a multi-processor cluster.

The memory 106 of the SoC 102 may be a volatile or non-volatile memory configured for storing data and processor-executable code for access by the processor 104 or by other components of SoC 102, including an edge processor 124. The computing device 100 and/or SoC 102 may include one or more memories 106 configured for various purposes. One or more memories 106 may include volatile memories such as random access memory (RAM) or main memory, or cache memory. These memories 106 may be configured to temporarily hold a limited amount of data received from a data sensor or subsystem, data and/or processor-executable code instructions that are requested from non-volatile memory, loaded to the memories 106 from non-volatile memory in anticipation of future access based on a variety of factors, and/or intermediary processing data and/or processor-executable code instructions produced by the processor 104 and/or edge processor 124 and temporarily stored for future quick access without being stored in non-volatile memory. In some embodiments, any number and combination of memories 106 may include one-time programmable or read-only memory.

The memory 106 may be configured to store data and processor-executable code, at least temporarily, that is loaded to the memory 106 from another memory device, such as another memory 106 or memory 114, for access by one or more of the processors 104 or by other components of SoC 102, including the edge processor 124. The data or processor-executable code loaded to the memory 106 may be loaded in response to execution of a function by the processor 104 or by other components of SoC 102, including the edge processor 124. Loading the data or processor-executable code to the memory 106 in response to execution of a function may result from a memory access request to the memory 106 that is unsuccessful, or a “miss,” because the requested data or processor-executable code is not located in the memory 106. In response to a miss, a memory access request to another memory 106 or memory 114 may be made to load the requested data or processor-executable code from the other memory 106 or memory 114 to the memory 106. Loading the data or processor-executable code to the memory 106 in response to execution of a function may result from a memory access request to another memory 106 or memory 114, and the data or processor-executable code may be loaded to the memory 106 for later access.

The memory interface 110 and the memory 114 may work in unison to allow the computing device 100 to store data and processor-executable code on a volatile and/or non-volatile storage medium, and retrieve data and processor-executable code from the volatile and/or non-volatile storage medium. The memory 114 may be configured much like an embodiment of the memory 106 in which the memory 114 may store the data or processor-executable code for access by one or more of the processors 104 or by other components of SoC 102, including the edge processor 124. In some embodiments, the memory 114, being non-volatile, may retain the information after the power of the computing device 100 has been shut off. When the power is turned back on and the computing device 100 reboots, the information stored on the memory 114 may be available to the computing device 100. In some embodiments, the memory 114, being volatile, may not retain the information after the power of the computing device 100 has been shut off. The memory interface 110 may control access to the memory 114 and allow the processor 104 or other components of the SoC 102, including the edge processor 124, to read data from and write data to the memory 114.

The SoC 102 may also include any number of edge processors 124. An edge processor 124 may be a processing device that may use existing, dedicated firmware toolchains for which machine learning models need to be adapted for use with the existing, dedicated firmware toolchains to be implemented by the edge processor 124. The edge processor may implement machine learning model processing locally on the computing device 100. The edge processor 124 may have limited compiler capabilities, memory, and/or processing power as compared to non-low power processor, such as non-low power CPUs, GPUs, etc.

The edge processor 124 may include any of a low power processor, a sensor DSP, a modem DSP, a memory control unit (MCU), an embedded processor, a controller, a microcontroller, etc. The edge processor(s) 124 may be individual components of the SoC 102 and/or integral components of other SoC components, such as the communication interface 108, the memory interface 110, and/or the peripheral device interface 120. The computing device 100 may also include edge processors 124 that are not associated with the SoC 102. Such edge processors 124 may be standalone components of the computing device 100 and/or integrated into other SoCs 102 and/or other computing device components, such as communication components 102 and peripheral devices 122.

Some or all of the components of the computing device 100 and/or the SoC 102 may be arranged differently and/or combined while still serving the functions of the various embodiments. The computing device 100 may not be limited to one of each of the components, and multiple instances of each component may be included in various configurations of the computing device 100.

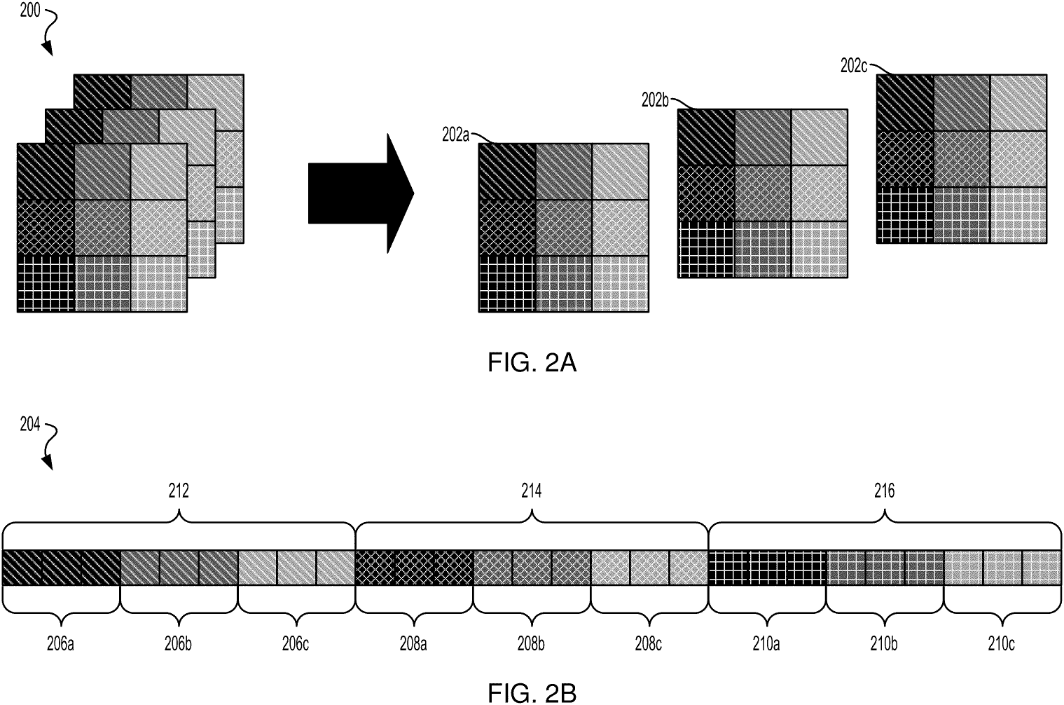

FIGS. 2A and 2B illustrate an example of weight tensor transformation suitable for implementing various embodiments. With reference to FIGS. 1, 2A, and 2B, a weight tensor 200 may be a multi-dimensional organization of weights. For example, the weight tensor 200 illustrated in FIG. 2A is a three-dimensional organization of weights, having a height, a width and a depth. The height may correspond to a number of rows, the width may correspond to a number of columns, and the depth may correspond to a number of channels of the weight tensor 200. In this example, the weight tensor may have a height of three rows of weights, a width of three columns of weights, and a depth of three channels weights. The weight tensor 200 may also be represented as two-dimensional channels 202a, 202b, 202c. Each channel 202a, 202b, 202c may represent a depth of the weight tensor 200, and each channel 202a, 202b, 202c may have the same height and width of the weight tensor 200. In the example illustrated in FIG. 2A, like shaded portions of the channels 202a, 202b, 202c may represent corresponding locations of weights in the channels 202a, 202b, 202c.

During execution of network construct source code for a trained machine learning model, memory (e.g., memory 106 in FIG. 1) is dynamically allocated to load the weights of the weight tensor 200. The weights may be loaded to the memory according to a pattern of access implemented by the network construct source code. The pattern of access can iterate over the quickest changing dimension of the weight tensor 200 causing frequent allocations of, evictions from, and writes to the memory to load the requested weights. In this example, the quickest changing dimension of the weight tensor 200 may be the depth, and the network construct source code may implement a pattern of access to iterate over the depth of the weight tensor 200. As a result, the memory may have to repeatedly load weights from the channels 202a, 202b, 202c for various accesses of weights at different height and width locations in the different channels. The repeated dynamic allocation of, eviction from, and writes to the memory is costly in terms of consumption of memory resources, such as space, bandwidth, and electric power.

Using a modified version of the network construct source code, a weight layout transformer, the execution of a trained machine learning model may implement a more efficient memory pattern of access. The weight layout transformer may be configured to implement a pattern of access such that the weights are loaded to the memory for the pattern of access iterating over a slower, such as a slowest, changing dimension of the weight tensor 200. In this example, the slowest changing dimension of the weight tensor 200 may be the rows, and the weight layout transformer may implement a pattern of access to iterate over the rows of the weight tensor 200. The pattern of access iterating over a slower changing dimension of the weight tensor 200 may improve data locality in the memory, as the pattern of access is configured to use more of the data, such as the weights, loaded to the memory per load.

FIG. 2B illustrates an example of weights of the weight tensor 200 accessed from memory using the pattern of access of the weight layout transformer. For example, the pattern of access may transform the multi-dimensional weight tensor 200 to a linear organization 204 of the weights. The pattern of access may include transforming the weight tensor 200 to a linear format 204 in a memory for use during execution of a trained neural network. In some embodiments, the linear format 204 may be a linear array. In some embodiments, the linear format 204 may be a linked list, a stack, a queue, etc. The linear format 204 of the weights may organize the weights in a manner to improve locality of the weights in the memory for more efficient use of memory resources. The organization of the weights in the linear format 204 may allow for the memory access pattern to be a sequential memory access pattern that may reduce the number of writes to and read of the memory to retrieve the weights. For example, the memory access pattern may be such that each weight may be accessed sequentially, such as using a stride-1 reference pattern of the linear layout 204 of a multi-dimensional weight tensor 200, such as a row-major layout.

The example illustrated in FIG. 2B shows an embodiment of a potential linear layout 204 of the weight tensor 200 as a row-major layout in which the weights may be organized in a manner having weights organized by each position in a row for each channel 202a, 202b, 202c. For example, the linear layout 204 may group together each row of weights 212, 214, 216, where like shading patterns represent weights from the same row in each channel 202a, 202b, 202c of the weight tensors 200. More specifically, the linear layout 204 may group together weights of a first row 212, weights of a second row 214, and weights of a third row 216. In each group of weights by row 212, 214, 216, the linear layout 204 may further group the weights by location in each row by channel 206a, 206b, 206c, 208a, 208b, 208c, 210a, 210b, 210c, where like shading levels represent weights from a same location in a row. More specifically, the linear layout 204 may group the weights of a first location of the first row for each channel 206a, the weights of a second location of the first row for each channel 206b, and the weights of a third location of the first row for each channel 206c. A similar pattern may be implemented for grouping the weights of a first location of the second row for each channel 208a and the third row for each channel 210a, the weights of a second location of the second row for each channel 208b and the third row for each channel 210b, and the weights of a third location of the second row for each channel 208c and the third row for each channel 210c.

When using a linear layout 204 for the weights, such as a row-major layout, the last index may be the fastest changing. Memory locations of weights may be computed from their indices as:

$$\begin{matrix}O f f s e t = n d + N d \\ ∗ \left(n d - 1 + N d - 1\right) \\ ∗ \left(n d - 2 + N d - 2\right) \\ ∗ \left(\left(\left(… + N 2 n 1\right) …\right)\right) {\sum }_{i = 1}^{d} \left({∐}_{j = i + 1}^{d} {N}_{j}\right) n i\end{matrix}$$

where “N” is a linear layout dimension, “n” is an index for accessing a specific element of the linear layout 204, and “d” is a feature map dimension. In the continued example, when using three-dimensional feature maps, d=3, and the last dimension (depth or channel) may change the fastest and the first dimension (height or row) may change the slowest. The offset for a given weight may be:

$${n}_{3} + {N}_{3} ∗ \left({n}_{2} + {N}_{2} ∗ {n}_{1}\right)$$

The dimensionality, size, and organization of the weight tensor 200 and linear layout 204 in the foregoing examples are used for clarity and ease of explanation, and do not limit the scope of the claims and specification. It is conceived that various embodiments may use weight tensors of different dimensionality, size, and/or organization, and corresponding linear layouts of different size and/or organization.

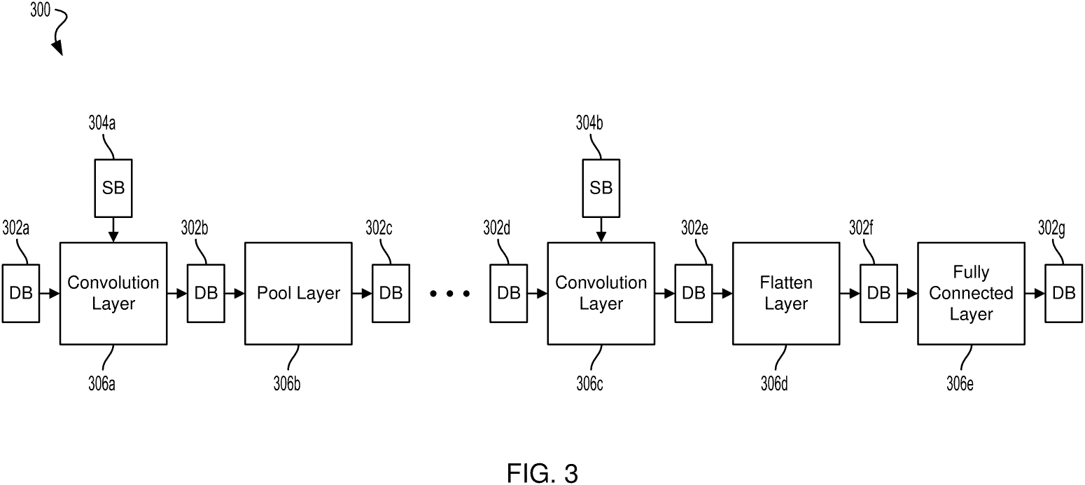

FIG. 3 illustrates an example trained machine learning model 300 execution using a linear weight layout of a weight tensor according to various embodiments. With reference to FIGS. 1-3, the trained machine learning model 300 may be implemented by an edge processor (e.g., edge processor(s) 124 and other edge processors described with reference to FIG. 1) using modified network construct source code, such as a weight layout transformer, and a weight corrector to generate inferences. The trained machine learning model 300 may consist of any type of machine learning model having any number and combination of layers. The following example is explained using a convolutional machine learning model for clarity and ease of explanation, and does not limit the scope of the claims and specification.

Each layer 306a, 306b, 306c, 306d, 306e of the trained machine learning model 300 may receive an input feature map from a dynamic buffer 302a, 302b, 302c, 302d, 302e, 302f (DB in FIG. 3) and output a feature map to a dynamic buffer 302b, 302c, 302d, 302e, 302f, 302g. The dynamic buffers 302a, 302b, 302c, 302d, 302e, 302f, 302g may be dynamically allocated parts of any number and combination of memories (e.g., memory 106 in FIG. 1). The dynamic buffers 302a, 302b, 302c, 302d, 302e, 302f, 302g may be used for loading and storing feature maps as the data in the feature maps may change between implementations of the trained machine learning model 300. For example, an input feature map be loaded to a dynamic buffer 302a that is configured to provide the input feature map to a first layer (convolution layer) 306a of the trained machine learning model 300. The data of the input feature map may affect the feature maps generated by each layer of the 306a, 306b, 306c, 306d, 306e of the trained machine learning model 300 and loaded to each successive dynamic buffer 302b, 302c, 302d, 302e, 302f, 302g. A different input feature map may be loaded to the dynamic buffer 302a and may result in different feature maps generated by each layer of the 306a, 306b, 306c, 306d, 306e of the trained machine learning model 300 and loaded to each successive dynamic buffer 302b, 302c, 302d, 302e, 302f, 302g. The various feature maps may vary in content and size.

At least some layers (convolution layers) 306a, 306c of the trained machine learning model 300 may also receive weights from a static buffer 304a, 304b (SB in FIG. 3). The static buffers 304a, 304b may be statically allocated parts of any number and combination of memories (e.g., memory 106 in FIG. 1). The static buffers 304a, 304b may be used for loading and storing weights as the weights may be static for multiple implementations of the trained machine learning model 300. For example, regardless of the feature maps loaded to the dynamic buffers 302a, 302b, 302c, 302d, 302e, 302f, the weights loaded to the static buffers 304a, 304b for the respective layers 306a, 306c of the trained machine learning model 300 may not vary from implementation to implementation of the trained machine learning model 300. The weights may be constant in content and size.

Regardless of the static nature of the weights loaded to the static buffers 304a, 304b, the static buffers 304a, 304b may not be large enough in some cases to load all of the weights from a weight tensor (e.g., weight tensor 200 in FIG. 2A). The weights may be loaded to the static buffers 304a, 304b in a manner that reflects a pattern of access of the static buffers 304a, 304b for implementing the respective layers 306a, 306c of the trained machine learning model 300. The pattern of access for implementing the respective layers 306a, 306c may be controlled by the network construct source code for implementing the respective layers 306a, 306c. Depending on the pattern of access for implementing the respective layers 306a, 306c, weights may be loaded but not all of the loaded weights may be accessed for a first access of a static buffer 304a, 304b, the weights may be evicted while a second access of the static buffer 304a, 304b access different weights, and the weights may be reloaded and accessed for a third access of the static buffer 304a, 304b. Each access of a static buffer 304a, 304b may correspond to an execution of a loop of the network construct source code. The more loops that are executed, the more accesses that are need to retrieve weights from a static buffer 304a, 304b. Loading weights when not needed for the first access of the static buffer 304a, 304b and reloading the weights when needed for the third access of the static buffer 304a, 304b may consume unnecessary memory resources, such as space, bandwidth, and electric power.

In some embodiments, rather than implementing inefficient network construct source code for implementing the respective layers 306a, 306c, the edge processing device may implement a weight layout transformer and/or a weight corrector. The weight layout transformer may be a modified version of the network construct source code configured to retrieve the same weights from the static buffer 304a, 304b for implementing the respective layer 306a, 306c using a pattern of access of the static buffers 304a, 304b that differs from the pattern of access of the network construct source code.

The pattern of access of the weight layout transformer may prompt the static buffer 304a, 304b to load the weights in an ordered manner such that more of the weights, up to all of the weights, that are loaded may be used for an access of the static buffer 304a, 304b. For example, the pattern of access of the static buffers 304a, 304b of the weight layout transformer may prompt the static buffer 304a, 304b to load the weights in a linear layout (e.g., linear layout 204 in FIG. 2B). In a further example, the linear layout may be a linear array. The linear format may group weights from a same location in the weight tensor across a slowest changing dimension of the weight tensor. For example, the linear format may group weights from a same location in a row of the weight tensor for each depth and column of the weight tensor.

As the weight layout transformer iterates through loops for executing a respective layer 306a, 306c, the pattern of accesses may sequentially iterate along the linear format, successively accessing each weight loaded to the static buffers 304a, 304b. Accessing all of the weights when loaded to the static buffers 304a, 304b by successive loops may obviate the need to reload the weights for a successive loop, conserving memory resource that would otherwise be used for extra memory loads and evictions using the pattern of access of the network construct source code. Further, the pattern of access for retrieving the weights may be synchronous to the pattern for the calculations using the weights and feature map inputs for execution of the respective layer 306a, 306c. This synchronicity may cause fewer memory accesses to retrieve weights for the calculations. Fewer memory accesses may need fewer cycles, fewer iterations, and/or fewer packets to achieve the weight retrieval of the weight tensor from the static buffers 304a, 304b for execution of the respective layer 306a, 306c.

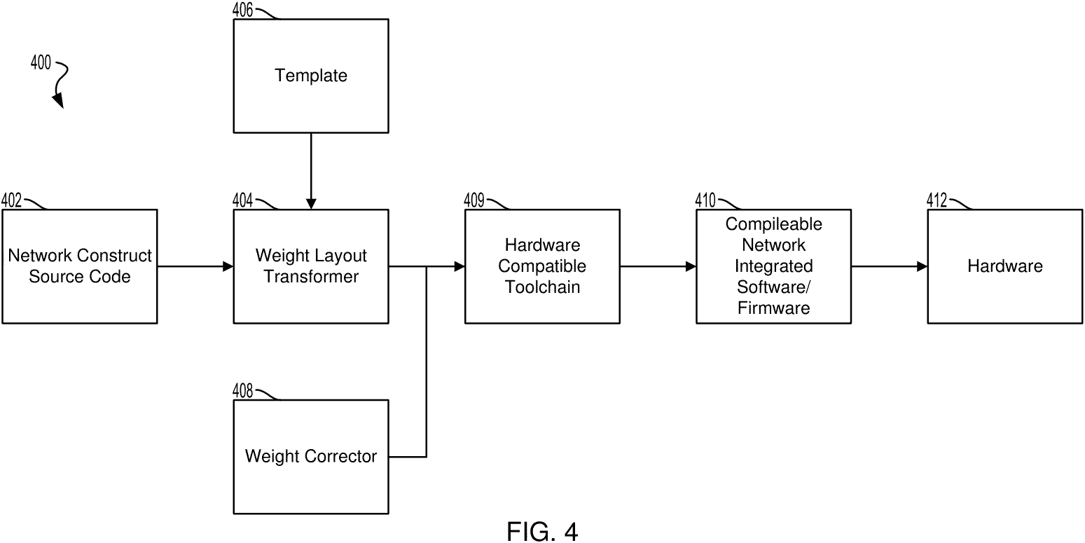

FIG. 4 illustrates an example system for implementing source code of trained machine learning models configured for weight tensor transformation according to various embodiments. With reference to FIGS. 1-4, a weight layout transformation system 400 may be implemented by a processor (e.g., processor 104, edge processor 124 in FIG. 1).

In the weight layout transformation system 400, a network construct source code 402, a high-level programming language version of a trained machine learning model, may be converted to a weight layout transformer 404. In some embodiments, the network construct source code 402 may be converted to a weight layout transformer 404 manually by a developer. In some embodiments, the processor may be configured to match and select a template 406 for converting the network construct source code 402 to the weight layout transformer 404. The processor may use the template 406 to modify the network construct source code 402 to generate the weight layout transformer 404. In some embodiments, the template 406 may be preconfigured and stored on a memory (e.g., memory 106, 114 in FIG. 1). Matching and/or selecting the template 406 may be based on analysis of the network construct source code 402, including the metadata and/or the source code, to identify a type of trained machine learning model and/or a type of layer of the trained machine learning model, and to identify a template 406 for the type of trained machine learning model and/or a type of layer. The weight layout transformer 404 may be configured to implement the same trained machine learning model as the network construct source code 402 using a more efficient memory access pattern to retrieve weights of the trained machine learning model from a memory (e.g., memory 106 in FIG. 1).

The more efficient memory access pattern may retrieve the weights in a transformed order that is unexpected or incompatible with the execution of computations of the trained machine learning model. The weight corrector 408 may be configured to correct the order of the weights retrieved from the memory to be used for the computations of the trained machine learning mode. For example, the weight corrector 408 may correct the transformed order of the weights retrieved from the memory by the weight layout transformer 404 to the order in which the weights would be retrieved by the network construct source code 402. The weight corrector 408 may be generated and/or selected (e.g., by the processor) for the weight layout transformer 404. In some embodiments, the weight corrector 408 may be generated manually by a developer. In some embodiments, the weight corrector 408 may be automatically generated by the processor analyzing the memory access patterns of the network construct source code 402 and the weight layout transformer 404. In some embodiments, the weight corrector 408 may be preconfigured and stored on a memory (e.g., memory 106, 114 in FIG. 1). The processor may be configured to select the weight corrector 408 based on analysis of the network construct source code 402, including the metadata and/or the source code, to identify a type of trained machine learning model and/or a type of layer of the trained machine learning model, and to identify a weight corrector 408 for the type of trained machine learning model and/or a type of layer.

A software and/or firmware developer, which may also be a hardware developer of a hardware 412 (e.g., edge processor 124 in FIG. 1), may develop software and/or firmware for execution by the hardware 412 using a hardware compatible toolchain 409, which is also referred to herein as an existing, dedicated firmware toolchain. The software and/or firmware may be a compliable network integrated software and/or firmware 410 that incorporates the weight layout transformer 404 and the weight corrector 408 to implement a trained machine learning model by the hardware 412.

In some embodiments, the network integrated software and/or firmware 410 may be compiled and provided in an executable format to the hardware 412. In some embodiments, the network integrated software and/or firmware 410 may be provided to the hardware 412. The hardware 412 may compile the network integrated software and/or firmware 410 to an executable format. The hardware 412 may execute the compiled network integrated software and/or firmware 410. Executing the compiled network integrated software and/or firmware 410 may cause the hardware 412 to implement the trained machine learning model.

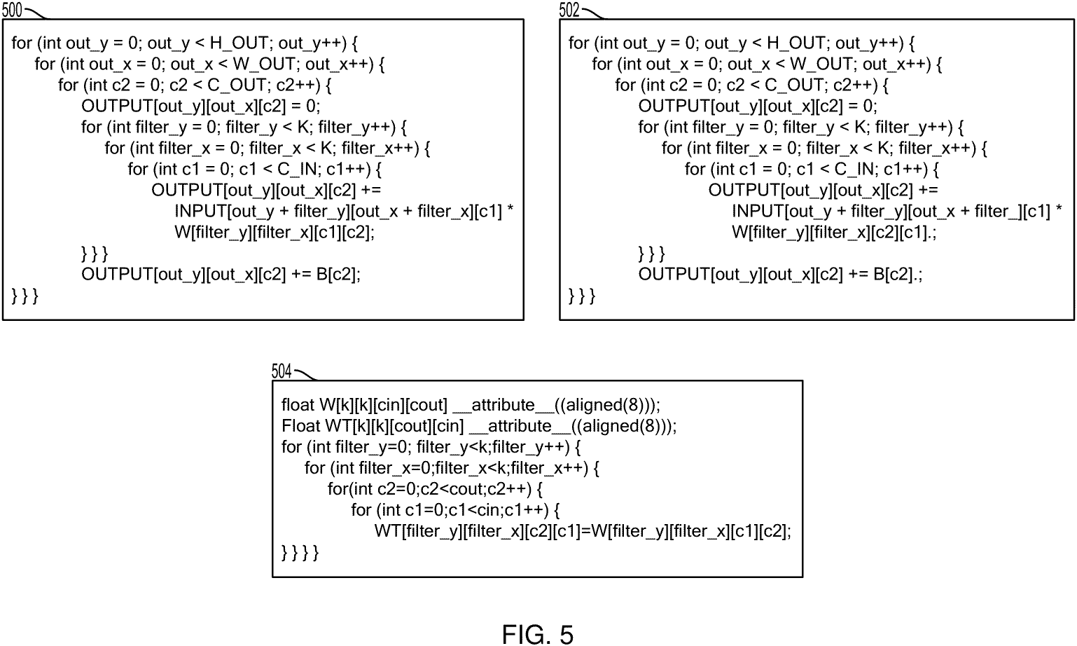

FIG. 5 illustrates example computer code for source code of trained machine learning models configured for weight tensor transformation according to various embodiments. With reference to FIGS. 1-5, a code block 500 may correspond with a network construct source code (e.g., network construct source code 402 in FIG. 4) for a trained machine learning model and/or a layer of a trained machine learning model. A code block 502 may correspond with a weight layout transformer (e.g., weight layout transformer 404 in FIG. 4) for the network construct source code. A code block 504 may correspond with a weight corrector (e.g., weight corrector 408 in FIG. 4) for the weight layout transformer. For convenience, the code block 500, the code block 502, and the code block 504 may sometimes be referred to as the first code block 500, the second code block 502, and the third code block 504, respectively.

As shown in the example illustrated in FIG. 5, the code block 500 may execute weight retrieval for the trained machine learning model and/or the layer of a trained machine learning model using nested loops. The nested loops may control iterative execution of weight retrieval from a weight tensor (e.g., weight tensor 200 in FIG. 2) for execution of the trained machine learning model and/or the layer of a trained machine learning model using nested loops. The lowest level loop in the code block 500 iterates over the quickest changing dimension of the weight tensor.

Continuing with the previous examples, the lowest level loop iterates over a depth or a channel (e.g., channel 202a, 202b, 202c in FIG. 2B) of the weight tensor. However, the pattern of access of a memory (e.g., memory 106 in FIG. 1) to retrieve the weights using the nested loops may not correspond to an efficient pattern of access to retrieve the weights needed to implement calculations using the weights and feature map inputs for execution of the trained machine learning model and/or the layer of a trained machine learning model. In other words, the pattern of access for retrieving the weights may be asynchronous to the pattern for the calculations using the weights and feature map inputs for execution of the trained machine learning model and/or the layer of a trained machine learning model. This asynchronicity may cause excess memory accesses to retrieve weights for the calculations. In the example illustrated in FIG. 5, the code block 500 accesses memory to retrieve weights from the weight tensor at locations corresponding to ordered counter values of the nested loops. For example, “W[filter_y][fitler_x][c1][c2]” may retrieve the weight values from memory for a weight tensor location corresponding to the ordered counter values “[filter_y][fitler_x][c1][c2].”

The code block 502 may be a modification of the code block 500. The code block 502 may execute weight retrieval for the trained machine learning model and/or the layer of a trained machine learning model using nested loops. However, the lowest level loop of the code block 500 may be modified in the code block 502. The lowest level loop in the code block 502 may iterate over a slower, such as a slowest, changing dimension of the weight tensor.

Continuing with the previous examples, the lowest level loop may iterate over a height or a row of the weight tensor. The pattern of access of the memory to retrieve the weights using the nested loops may correspond to a more efficient pattern of access to retrieve the weights needed to implement calculations using the weights and feature map inputs for execution of the trained machine learning model and/or the layer of a trained machine learning model. For example, the pattern of access may cause the weights to load to the memory as a linear layout (e.g., linear layout 204 in FIG. 2B). In a further example, the linear layout may be a linear array. The linear format may group weights from a same location in the weight tensor across a slowest changing dimension of the weight tensor. For example, the linear format may group weights from a same location in a row for each channel and column of the weight tensor.

As the weight layout transformer iterates through loops for executing an execution of the trained machine learning model and/or the layer of a trained machine learning model, the pattern of accesses may sequentially iterate along the linear format, successively accessing each weight loaded to the memory. Accessing all of the weights when loaded to the memory by successive loops may obviate the need to reload the weights for a successive loop, conserving memory resource that would otherwise be used for extra memory loads and evictions using the pattern of access of the network construct source code. Further, the pattern of access for retrieving the weights may be synchronous to the pattern for the calculations using the weights and feature map inputs for execution of the trained machine learning model and/or the layer of a trained machine learning model. This synchronicity may cause fewer memory accesses to retrieve weights for the calculations. Fewer memory accesses may need fewer cycles, fewer iterations, and/or fewer packets to achieve the weight retrieval of the weight tensor from the memory for execution of the trained machine learning model and/or the layer of a trained machine learning model.

In the example illustrated in FIG. 5, the code block 502 may access memory to retrieve weights from the weight tensor at locations corresponding to ordered counter values of the nested loops. For example, “W[filter_y][fitler_x][c2][c1]” may retrieve the weight values from memory for a weight tensor location corresponding to the ordered counter values “[filter_y][fitler_x][c2][c1].” In this example, the counter values [c1] and [c2] are transposed relative to the code block 500, which changes the order in which the code block 502 retrieves the weights from memory, referred to herein as a transformed order, as compared to the order in which the code block 500 retrieves the weights from memory.

The more efficient pattern of access of the memory to retrieve the weights implemented by the code block 502 retrieves the weights in a transformed order different from an order that may be expected by the execution for the calculations of the machine learning model and/or the layer of a trained machine learning model. Using the weights in the order retrieved by the code block 502 may produce incorrect results of the calculations. The code block 504 may be configured to correct the order of the weights retrieved from the memory by the code block 502 to provide the weights for execution of the calculations of the machine learning model and/or the layer of a trained machine learning model. For example, the code block 504 recompose the order of the weights retrieved from memory by the code block 502 to match the order of the weights as if the weights were retrieved from memory by the code block 500.

Continuing with the above example, the code block 504 may reorder the weights retrieved from memory by undoing the transposition of the order of the counter values used to retrieve the weights from memory by the code block 502 so that the order of the counter values correspond to the order of the counter values in block 500. In the example illustrated in FIG. 5, “WT[filter_y][filter_x][c2][c1]=W[filter_y][filter_x][c1][c2]” may reorder the weights retrieved from memory using the order of “[filter_y][fitler_x][c2][c1]” as in block 502 to the order of “[filter_y][fitler_x][c1][c2]” as in block 500.

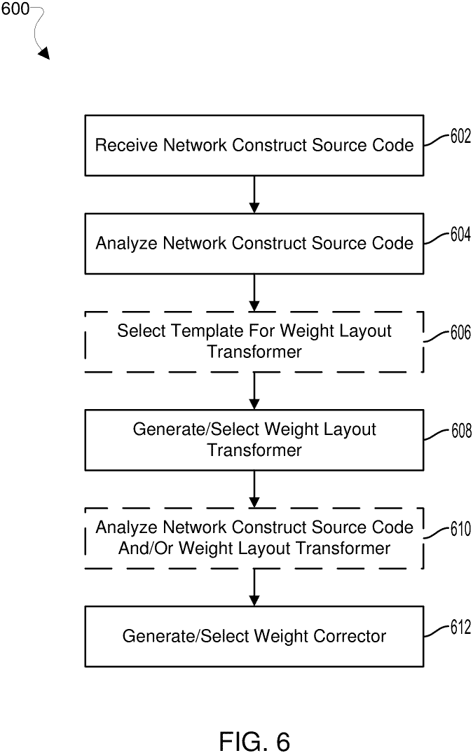

FIG. 6 illustrates a method 600 for generating source code of trained machine learning model execution using weight tensor transformation according to some embodiments. With reference to FIGS. 1-6, the method 600 may be implemented in a computing device (e.g., computing device 100 in FIG. 1), in general purpose hardware (e.g., processor 104 in FIG. 1), in dedicated hardware (e.g., edge processor(s) 124 and other edge processors described with reference to FIG. 1), in software executing in a processor (e.g., weight layout transformation system 400, weight layout transformer 404, template 406, weight corrector 408 in FIG. 4 and described with reference to FIG. 2A-5), or in a combination of a software-configured processor and dedicated hardware. In order to encompass the alternative configurations enabled in various embodiments, the hardware implementing the method 600 is referred to herein as a “processing device.”

In block 602, the processing device may receive a network construct source code (e.g., network construct source code 402 in FIG. 4 and described with reference to FIG. 2A-5). As described herein, the network construct source code may be in a high-level programming language for a trained machine learning model that may be compiled and implemented by edge processing devices. In some embodiments, the processing device receiving the network construct source code in block 602 may be one or more general purpose processors. In some embodiments, the processing device receiving the network construct source code in block 602 may be one or more edge processing devices.

In block 604, the processing device may analyze the network construct source code received in block 602. In some embodiments, the processing device may be configured to read metadata of the network construct source code and identify a type of trained machine learning model and/or trained machine learning model layer of the network construct source code. In some embodiments, the processing device may be configured to parse the network construct source code to locate and identify layers of the trained machine learning model. The processing device may be configured to parse the network construct source code to locate and identify a type of network layer, network layer execution, network layer flow control, and/or memory access command for weight retrieval of the network construct source code. The processing device may be configured to locate and identify code that matches criteria for a format of the type of network layer, network layer execution, network layer flow control, and/or memory access command for weight retrieval of the network construct source code. For example, the type of network layer, network layer execution, network layer flow control, and/or memory access command for weight retrieval of the network construct source code may use specific function calls, specific code patterns, such as loops, be labeled using specific identifiers, etc. In some embodiments, different criteria may be used by the processing device to parse the network construct source code to locate and identify the type of network layer, network layer flow control, and/or memory access command for weight retrieval of the network construct source code of different trained machine learning models. In some embodiments, the processing device analyzing the network construct source code in block 604 may be one or more general purpose processors. In some embodiments, the processing device analyzing the network construct source code in block 604 may be one or more edge processing devices.

In optional block 606, the processing device may select a template for a weight layout transformer. The processing device may identify the metadata and/or contents of the network construct source code that meet the criteria for identifying weight layout transformers. The processing device may compare the metadata and/or contents of the network construct source code to the criteria for identifying weight layout transformers, and identify a weight layout transformer from metadata and/or content that meets the criteria. The processing device may be configured to select a template (e.g., from a memory 106, 114 in FIG. 1) for a weight layout transformer based on the identified type of network layer, network layer execution, network layer flow control, and/or memory access command for weight retrieval of the network construct source code. Each template for a weight layout transformer may correspond to a type of network and/or layer of a network. Templates for weight layout transformers may be preconfigured to correspond with any network and/or type of network layer. A template for a weight layout transformer may be configured to provide source code for execution, flow control, and memory access commands for weight retrieval for a type of network and/or network layer in a programming language that is compileable and executable by an edge processing device. For example, the template for a weight layout transformer may include specific function calls, specific code patterns, such as loops, specific identifiers, specific memory access commands, etc. that are configured to implement the network and/or network layer execution and flow control.

In some embodiments, different templates for weight layout transformers may include different code for implementing network and/or network layer execution, flow control, and memory access commands for weight retrieval for different networks and/or layers of different trained machine learning models. In some embodiments, the processing device selecting a template for a weight layout transformer in block 606 may be one or more general purpose processors. In some embodiments, the processing device selecting a template for a weight layout transformer in block 606 may be one or more edge processing devices.

In block 608, the processing device may generate and/or select a weight layout transformer. In some embodiments, the processing device may read the selected template for the weight layout transformer. The processing device may be configured to generate weight layout transformer code for use in executing a trained machine learning model and/or a layer of the trained machine learning model using selected layer templates. In some embodiments, the processing device may read the code of the selected template for the weight layout transformer. Reading the selected template for the weight layout transformer may provide the processing device with source code for initialization, execution, flow control, and/or memory access commands of the trained machine learning model and/or a layer of the trained machine learning model. In some embodiments, the processing device may write out the code of the selected template for the weight layout transformer to a memory (e.g., memory 106, 114 in FIG. 1). In some embodiments, the processing device may modify the network construct source code by changing and/or replacing memory access commands for retrieving weights from a memory (e.g., memory 106 in FIG. 1) to memory access commands for retrieving weights from the memory specified in the template for the weight layout transformer. For example, the processing device may change and/or replace memory access commands for retrieving weights in a lowest level loop of nested loops. In some embodiments, the processing device generating the weight layout transformer in block 608 may be one or more general purpose processors. In some embodiments, the processing device generating the weight layout transformer in block 608 may be one or more edge processing devices.

In some embodiments, the weight layout transformer may be preconfigured and stored in the memory of a computing device, and the processing device may select the weight layout transformer to use instead of the network construct source code based on the analysis of the network construct source code in block 604. The processing device may identify the metadata and/or contents of the network construct source code that meet the criteria for identifying weight layout transformers. The processing device may compare the metadata and/or contents of the network construct source code to the criteria for identifying weight layout transformers, and identify a weight layout transformer from metadata and/or content that meets the criteria. The processing device may be configured to select a weight layout transformer based on the identified type of network layer, network layer execution, network layer flow control, and/or memory access command for weight retrieval of the network construct source code. Each weight layout transformer may correspond to a type of network and/or layer of a network. Weight layout transformers may be preconfigured to correspond with any network and/or type of network layer. In some embodiments, the processing device selecting the weight layout transformer in block 608 may be one or more general purpose processors. In some embodiments, the processing device selecting the weight layout transformer in block 608 may be one or more edge processing devices.

In optional block 610, the processing device may analyze the weight layout transformer. In some embodiments, the processing device may be configured to read metadata of the weight layout transformer and identify a type of trained machine learning model and/or trained machine learning model layer of the weight layout transformer. The processing device may identify how the weight layout transformer differs from the network construct source code. For example, the processing device may identify the different memory access commands for retrieving weights from the memory in the weight layout transformer as compared to the network construct source code. In some embodiments, the processing device may be configured to parse the weight layout transformer to locate and identify memory access commands for retrieving weights. The processing device may be configured to locate and identify code that matches criteria for memory access commands for retrieving weights. In some embodiments, different criteria may be used by the processing device to parse the weight layout transformer to locate and identify the memory access commands for weight retrieval of the weight layout transformer of different trained machine learning models. In some embodiments, the processing device analyzing the weight layout transformer in block 610 may be one or more general purpose processors. In some embodiments, the processing device analyzing the weight layout transformer in block 610 may be one or more edge processing devices.

In block 612, the processing device may generate and/or select a weight corrector. In some embodiments, the processing device may be configured to generate weight layout corrector for use in executing a trained machine learning model and/or a layer of the trained machine learning model from analysis of the network construct source code in block 604 and/or the weight layout transformer in optional block 610. In some embodiments, the processing device may read the code of the network construct source code and/or the weight layout transformer. Reading the network construct source code and/or the weight layout transformer may provide the processing device with source code for memory access commands for retrieving weights. In some embodiments, the processing device may generate code of the weight corrector for returning the order of the weights retrieved from memory by the weight layout transformer, referred to herein as a transformed order, to the order of the weights that would be retrieved from memory by the network construct source code, and store the code of the weight corrector to a memory (e.g., memory 106, 114 in FIG. 1). In some embodiments, the processing device generating the weight corrector in block 612 may be one or more general purpose processors. In some embodiments, the processing device generating the weight corrector in block 612 may be one or more edge processing devices.

In some embodiments, the weight layout corrector may be preconfigured and stored in the memory of a computing device. The processing device may select the weight layout corrector to use based on the analysis of the network construct source code in block 604 and/or the weight layout transformer in optional block 610. The processing device may identify the metadata and/or contents of the network construct source code and/or the weight layout transformer that meet the criteria for identifying weight correctors. The processing device may compare the metadata and/or contents of the network construct source code and/or the weight layout transformer to the criteria for identifying weight correctors, and identify a weight layout transformer from metadata and/or content that meets the criteria. The processing device may be configured to select a weight corrector based on the identified type of network layer, network layer execution, network layer flow control, and/or memory access command for weight retrieval of the network construct source code and/or the weight layout transformer. Each weight corrector may correspond to a type of network and/or layer of a network. Weight correctors may be preconfigured to correspond with any network and/or type of network layer. In some embodiments, the processing device selecting the weight corrector in block 612 may be one or more general purpose processors. In some embodiments, the processing device selecting the weight corrector in block 612 may be one or more edge processing devices.

In some embodiments, any or all of blocks 602, 604, 606, 608, 610, 612 may be implemented for each network layer of the trained machine learning model.

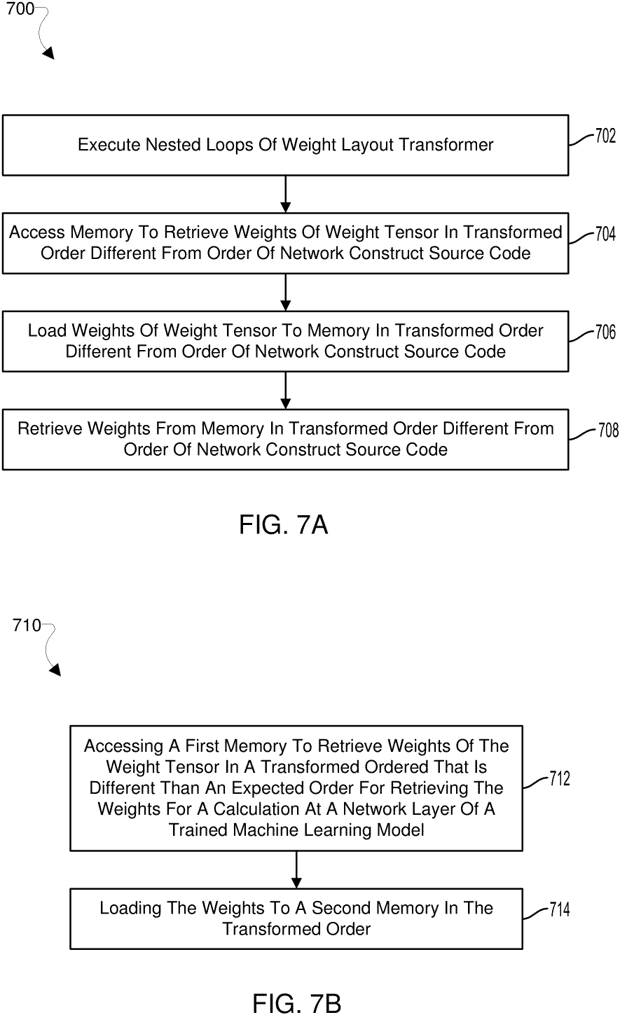

FIG. 7A illustrates a method 700 for weight layout transformation according to some embodiments. With reference to FIG. 1-7A, the method 700 may be implemented in a computing device (e.g., computing device 100 in FIG. 1), in general purpose hardware (e.g., processor 104 in FIG. 1), in dedicated hardware (e.g., edge processor(s) 124 and other edge processors described with reference to FIG. 1), in software executing in a processor (e.g., weight layout transformation system 400, weight layout transformer 404, in FIG. 4 and described with reference to FIG. 2A-5), or in a combination of a software-configured processor and dedicated hardware. In order to encompass the alternative configurations enabled in various embodiments, the hardware implementing the method 700 is referred to herein as a “processing device.”

In block 702, the processing device may execute nested loops of the weight layout translator. As described herein, the weight corrector may include nested loops configured to cause the weight layout translator to traverse a weight tensor (e.g., weight tensor 200 in FIG. 2) and retrieve weights of the weight tensor. An order in which the weight layout transformer retrieves the weights of the weight tensor from memory (e.g., memory 106 in FIG. 1), referred to herein as a transformed order, may differ from an order in which the network construct source code (e.g., network construct source code (e.g., network construct source code 402 in FIG. 4 and described with reference to FIG. 2A-5) retrieves the weights of the weight tensor from the memory. In some embodiments, the processing device executing the nested loops of the weight layout translator in block 702 may be one or more general purpose processors. In some embodiments, the processing device executing the nested loops of the weight layout translator in block 702 may be one or more edge processing devices.

In block 704, the processing device may access the memory to retrieve weights of the weight tensor in the transformed order that may be different from the order in which the network construct source would retrieve weights of the weight tensor. At some levels of the nested loops executed in block 702, the weight layout transformer may include memory access commands configured to retrieve weights of the weight tensor. In some embodiments, the level of the nested loops at which the weight layout transformer may include memory access commands configured to retrieve weights of the weight tensor may be a lowest level nested loop. The memory access commands may include variables, such as counter values, that may specify a location in the weight tensor from which to retrieve a weight. As the nested loops iterate, the values of the variables of the memory access commands may change, changing the location in the weight tensor from which to retrieve the weight. In some embodiments, an order of the variables for the memory access commands of the weight layout transformer may be different from an order of the variables for the memory access commands of the network construct source code. For example, the order of the variables for the memory access commands of the network construct source code may iterate over a fast changing dimension of the weight tensor, such as depth or channels (e.g., channel 202a, 202b, 202c in FIG. 2), and the order of the variables for the memory access commands of the weight layout transformer may iterate over a slower changing dimension of the weight tensor. In some embodiments, the processing device accessing the memory to retrieve weights of the weight tensor in the transformed order that may be different from the order in which the network construct source would retrieve weights of the weight tensor in block 704 may be one or more general purpose processors. In some embodiments, the processing device accessing the memory to retrieve weights of the weight tensor in the transformed order that may be different from the order in which the network construct source would retrieve weights of the weight tensor in block 704 may be one or more edge processing devices.

In block 706, the processing device may load weights of the weight tensor to the memory in response to the memory access requests of the weight layout transformer in the transformed order that may be different from an order for loading weights of the weight tensor to the memory in response to the memory access requests of the network construct source code. The processing device may load weights retrieved from the weight tensor to the memory. Based on the transformed order of weight retrieval specified by the memory access commands in block 704, the processing device may similarly load the weights to memory in the transformed order. In some embodiments, the processing device loading weights of the weight tensor to the memory in response to the memory access requests of the weight layout transformer in the transformed order that may be different from the order for loading weights of the weight tensor to the memory in response to the memory access requests of the network construct source code in block 706 may be one or more general purpose processors. In some embodiments, the processing device loading weights of the weight tensor to the memory in response to the memory access requests of the weight layout transformer in the transformed order that may be different from the order for loading weights of the weight tensor to the memory in response to the memory access requests of the network construct source code in block 706 may be one or more edge processing devices.

In block 708, the processing device may retrieve weights of the weight tensor from the memory in response to the memory access requests of the weight layout transformer in the transformed order that may be different from an order for retrieving weights of the weight tensor from the memory in response to the memory access requests of the network construct source code. The processing device may retrieve weights of the weight tensor loaded to the memory. Based on the transformed order of weight retrieval specified by the memory access commands in block 704, the processing device may similarly retrieve the weights from memory in the transformed order. In some embodiments, the processing device retrieving weights of the weight tensor from the memory in response to the memory access requests of the weight layout transformer in the transformed order that may be different from an order for retrieving weights of the weight tensor from the memory in response to the memory access requests of the network construct source code in block 708 may be one or more general purpose processors. In some embodiments, the processing device retrieving weights of the weight tensor from the memory in response to the memory access requests of the weight layout transformer in the transformed order that may be different from an order for retrieving weights of the weight tensor from the memory in response to the memory access requests of the network construct source code in block 708 may be one or more edge processing devices.

In some embodiments, any or all of blocks 702, 704, 706, 708 may be implemented for each layer of the trained machine learning model. In some embodiments, any or all of blocks 702, 704, 706, 708 may be implemented in series and/or in parallel. In some embodiments, any or all of blocks 702, 704, 706, 708 may be implemented repeatedly and/or continuously. For example, the blocks 702, 704, 706, 708 may be implemented repeatedly and/or continuously for all of the iterations of the nested loops of the weight layout transformer.

FIG. 7B illustrates a method 710 for weight layout transformation according to some embodiments. With reference to FIG. 1-7B, the method 710 may be implemented in a computing device (e.g., computing device 100 in FIG. 1), in general purpose hardware (e.g., processor 104 in FIG. 1), in dedicated hardware (e.g., edge processor(s) 124 and other edge processors described with reference to FIG. 1), in software executing in a processor (e.g., weight layout transformation system 400, weight layout transformer 404, in FIG. 4 and described with reference to FIG. 2A-5), or in a combination of a software-configured processor and dedicated hardware. In order to encompass the alternative configurations enabled in various embodiments, the hardware implementing the method 710 is referred to herein as a “processing device.”

In block 712, the processing device may access a first memory (e.g., memory 106 in FIG. 1) to retrieve weights of the weight tensor (e.g., weight tensor 200 in FIG. 2) in a transformed order that is different than an order for retrieving the weights for a calculation at a network layer of a trained machine learning model. Block 712 may be implemented in a manner similar to the operations in block 704 of the method 700 as described with reference to FIG. 7A.

In block 714, the processing device may load the weights to a second memory (e.g., memory 106 in FIG. 1) in the transformed order. Block 714 may be implemented in a manner similar to the operations in block 706 of the method 700 as described with reference to FIG. 7A. In some embodiments, the first memory and the second memory may be within the same memory device, such as different partitions within the same memory device.

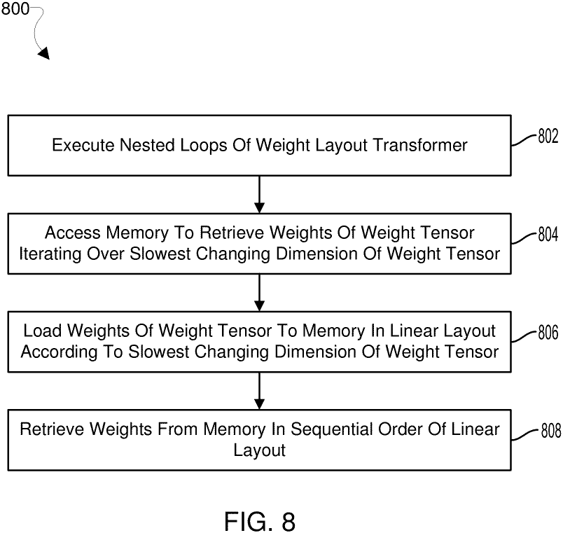

FIG. 8 illustrates a method 800 for weight layout transformation according to some embodiments. With reference to FIGS. 1-8, the method 800 may be implemented in a computing device (e.g., computing device 100 in FIG. 1), in general purpose hardware (e.g., processor 104 in FIG. 1), in dedicated hardware (e.g., edge processor(s) 124 and other edge processors described with reference to FIG. 1), in software executing in a processor (e.g., weight layout transformation system 400, weight layout transformer 404 in FIG. 4 and described with reference to FIG. 2A-5), or in a combination of a software-configured processor and dedicated hardware. In order to encompass the alternative configurations enabled in various embodiments, the hardware implementing the method 800 is referred to herein as a “processing device.” In some embodiments, the method 800 may further describe the method 700 described herein with reference to FIG. 7.

In block 802, the processing device may execute nested loops of the weight layout translator. As described herein, the weight corrector may include nested loops configured to cause the weight layout translator to traverse a weight tensor (e.g., weight tensor 200 in FIG. 2) and retrieve weights of the weight tensor. An order in which the weight layout transformer retrieves the weights of the weight tensor from memory (e.g., memory 106 in FIG. 1), referred to herein as a transformed order, may differ from an order in which the network construct source code (e.g., network construct source code (e.g., network construct source code 402 in FIG. 4 and described with reference to FIG. 2A-5) retrieves the weights of the weight tensor from the memory. In some embodiments, the processing device executing the nested loops of the weight layout translator in block 802 may be one or more general purpose processors. In some embodiments, the processing device executing the nested loops of the weight layout translator in block 802 may be one or more edge processing devices. In some embodiments, block 802 may further describe block 702 of the method 700 described herein with reference to FIG. 7.

In block 804, the processing device may access the memory to retrieve weights of the weight tensor iterating a slowest changing dimension of the weight tensor. At some levels of the nested loops executed in block 802, the weight layout transformer may include memory access commands configured to retrieve weights of the weight tensor. In some embodiments, the level of the nested loops at which the weight layout transformer may include memory access commands configured to retrieve weights of the weight tensor may be a lowest level nested loop. The memory access commands may include variables, such as counter values, that may specify a location in the weight tensor from which to retrieve a weight. As the nested loops iterate, the values of the variables of the memory access commands may change, changing the location in the weight tensor from which to retrieve the weight. In some embodiments, an order of the variables for the memory access commands of the weight layout transformer may iterate over a slowest changing dimension of the weight tensor. In some embodiments, the slowest changing dimension of the weight tensor may be the height or rows. In some embodiments, the order of the variables for the memory access commands of the weight layout transformer for specifying a location in the weight tensor may be transposed relative to an order of the variables for memory access commands of the network construct source code for specifying a location in the weight tensor. In some embodiments, the processing device accessing the memory to retrieve weights of the weight tensor iterating a slowest changing dimension of the weight tensor in block 804 may be one or more general purpose processors. In some embodiments, the processing device accessing the memory to retrieve weights of the weight tensor iterating a slowest changing dimension of the weight tensor in block 804 may be one or more edge processing devices.

In block 806, the processing device may load weights of the weight tensor to the memory in a liner layout according to the slowest changing dimension of the weight tensor. The processing device may load weights retrieved from the weight tensor to the memory. Based on the different order of weight retrieval specified by the memory access commands in block 804, the processing device may similarly load the weights to the memory in the different order, such as in a linear layout (e.g., linear layout 204 in FIG. 2) ordered according to the slowest changing dimension of the weight tensor. In some embodiments, the weight layout transformer may arrange the retrieved weights in a linear array in the memory. In some embodiments, the weight layout transformer may arrange the retrieved weights in a linear data structure in the memory, such as a linked list, a stack, a queue, etc. In some embodiments, the linear layout may be a row-major layout in which the weights may be organized by each position in a row for each channel. For example, the linear layout may group together each row of weights (e.g., row of weights 212, 214, 216 in FIG. 2B). In each group of weights by row, the linear layout may further group the weights by location in each row by channel (e.g., location in each row by channel 206a, 206b, 206c, 208a, 208b, 208c, 210a, 210b, 210c in FIG. 2B). In some embodiments, the processing device loading weights of the weight tensor to the memory in a liner layout according to the slowest changing dimension of the weight tensor in block 806 may be one or more general purpose processors. In some embodiments, the processing device loading weights of the weight tensor to the memory in a liner layout according to the slowest changing dimension of the weight tensor in block 806 may be one or more edge processing devices.

In block 808, the processing device may retrieve weights of the weight tensor from the memory in sequential order of the linear layout. The processing device may retrieve weights of the weight tensor loaded to the memory. Based on the order of weight retrieval specified by the memory access commands in block 804, the processing device may retrieve weights of the weight tensor from the memory in sequential order of the linear layout. The linear layout of the weights may organize the weights in a manner to improve locality of the weights in the memory for more efficient use of memory resources. The organization of the weights in the linear layout may allow for the memory accesses to be sequential memory accesses that may reduce the number of writes to and read of the memory to retrieve the weights. For example, the memory accesses may be such that each weight may be accessed sequentially, such as using a stride-1 reference pattern of the linear layout, such as with a row-major layout. In some embodiments, the processing retrieving weights of the weight tensor from the memory in sequential order of the linear layout in block 808 may be one or more general purpose processors. In some embodiments, the processing retrieving weights of the weight tensor from the memory in sequential order of the linear layout in block 808 may be one or more edge processing devices.

In some embodiments, any or all of blocks 802, 804, 806, 808 may be implemented for each layer of the trained machine learning model. In some embodiments, any or all of blocks 802, 804, 806, 808 may be implemented in series and/or in parallel. In some embodiments, any or all of blocks 802, 804, 806, 808 may be implemented repeatedly and/or continuously. For example, the blocks 802, 804, 806, 808 may be implemented repeatedly and/or continuously for all of the iterations of the nested loops of the weight layout transformer.

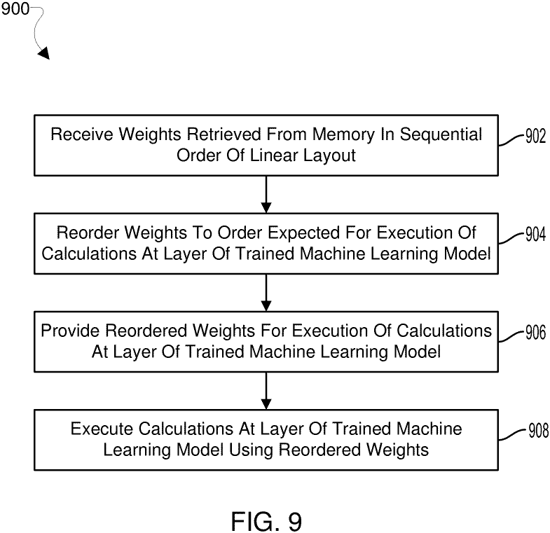

FIG. 9 illustrates a method 900 for weight correction according to some embodiments. With reference to FIGS. 1-9, the method 900 may be implemented in a computing device (e.g., computing device 100 in FIG. 1), in general purpose hardware (e.g., processor 104 in FIG. 1), in dedicated hardware (e.g., edge processor(s) 124 and other edge processors described with reference to FIG. 1), in software executing in a processor (e.g., weight layout transformation system 400, weight corrector 408 in FIG. 4 and described with reference to FIG. 2A-5), or in a combination of a software-configured processor and dedicated hardware. In order to encompass the alternative configurations enabled in various embodiments, the hardware implementing the method 900 is referred to herein as a “processing device.” In some embodiments, the method 900 may be a complimentary method to and may be implemented sequentially and/or in parallel with the methods 700, 800 described herein with reference to FIGS. 7 and 8.

In block 902, the processing device may retrieve weights from a memory (e.g., memory 106 in FIG. 1) in a sequential order of a linear layout (e.g., linear layout 204 in FIG. 2B). In some embodiments, the processing device may receive the weights retrieved from the memory in block 708 of the method 700 as described with reference to FIG. 7. In some embodiments, the processing device may receive the weights retrieved from the memory in block 808 of the method 800 as described with reference to FIG. 8. In some embodiments, the processing device reading weight data in block 902 may be one or more general purpose processors. In some embodiments, the processing device reading weight data in block 902 may be one or more edge processing devices.

In block 904, the processing device may reorder the weights to an order for execution of a calculation at a layer of a trained machine learning model. As discussed herein, the transformed order in which a weight layout transformer (e.g., weight layout transformer 404 in FIG. 4) retrieves weights from a weight tensor (e.g., weight tensor 200 in FIG. 2A) may be different from the order in which a network construct source code (e.g., network construct source code 304 as described with reference to FIGS. 3-5) would retrieve weights from the weight tensor. The order in which the network construct source code would retrieve weights may be the order in which a calculation at a layer of a trained machine learning model. The order in which the weight layout transformer retrieves weights may be unexpected and/or incompatible with the order for a calculation at a layer of a trained machine learning model. The processing device may instantiate variables, such as counter values, that may specify a location of a weight in the weight tensor. When the weights are accessed, the weights may be expected to correspond to the locations in the weight tensor according the values of the variables. For weights retrieved in a different order than expected, such as weights corresponding to locations in the weight tensor according values of variables in the weight layout transformer, the order of the weights may be reordered to the order using the expected values of the variables. The processing device may set weights received in a first order by the weight layout transformer to a second order using expected variable values. In some embodiments, the expected order of the variables for reordering the weights may be transposed relative to the order of the variables for the weights retrieved by the weight layout transformer. In some embodiments, the processing device reordering the weights to an order expected for execution of a calculation at a layer of a trained machine learning model in block 904 may be one or more general purpose processors. In some embodiments, the processing device reordering the weights to an order expected for execution of a calculation at a layer of a trained machine learning model in block 904 may be one or more edge processing devices.

In block 906, the processing device may provide the reordered weights for an execution of a calculation at a layer of a trained machine learning model. The processing device may receive a request for the weights in an execution of the calculation at the layer of the trained machine learning model and respond to the request by providing the reordered weights. In some embodiments, the request may be a request from a network to construct source code for implementing the calculation at the layer of the trained machine learning model. In some embodiments, the processing device providing the reordered weights for an execution of a calculation at a layer of a trained machine learning model in block 906 may be one or more general purpose processors. In some embodiments, the processing device providing the reordered weights for an execution of a calculation at a layer of a trained machine learning model in block 906 may be one or more edge processing devices.

In block 908, the processing device may execute the calculation at the layer of the trained machine learning model using the reordered weights. In some embodiments, the processing device may execute the network construct source code of the trained machine learning model and may execute the calculation at the layer of the trained machine learning model using the reordered weights. The network construct source code may include code for executing the calculation at the layer of the trained machine learning model. The network construct source code may be executed as standalone code and/or as incorporated into software and/or firmware. The calculations may be configured to provide an accurate result based on receiving weights in the order for a calculation at a layer of a trained machine learning model. The reordered weights may be configured in the order for a calculation at a layer of a trained machine learning model, and the calculation at the layer of the trained machine learning model may use the reordered weights. In some embodiments, the processing device executing the calculation at the layer of the trained machine learning model using the reordered weights in block 908 may be one or more general purpose processors. In some embodiments, the processing device executing the calculation at the layer of the trained machine learning model using the reordered weights in block 908 may be one or more edge processing devices.

In some embodiments, any or all of blocks 902, 904, 906, 908 may be implemented for each layer of the trained machine learning model. In some embodiments, any or all of blocks 902, 904, 906, 908 may be implemented in series and/or in parallel. In some embodiments, any or all of blocks 902, 904, 906, 908 may be implemented repeatedly and/or continuously. For example, the blocks 902, 904, 906, 908 may be implemented repeatedly and/or continuously for all of the weights for the layer of the trained machine learning model.

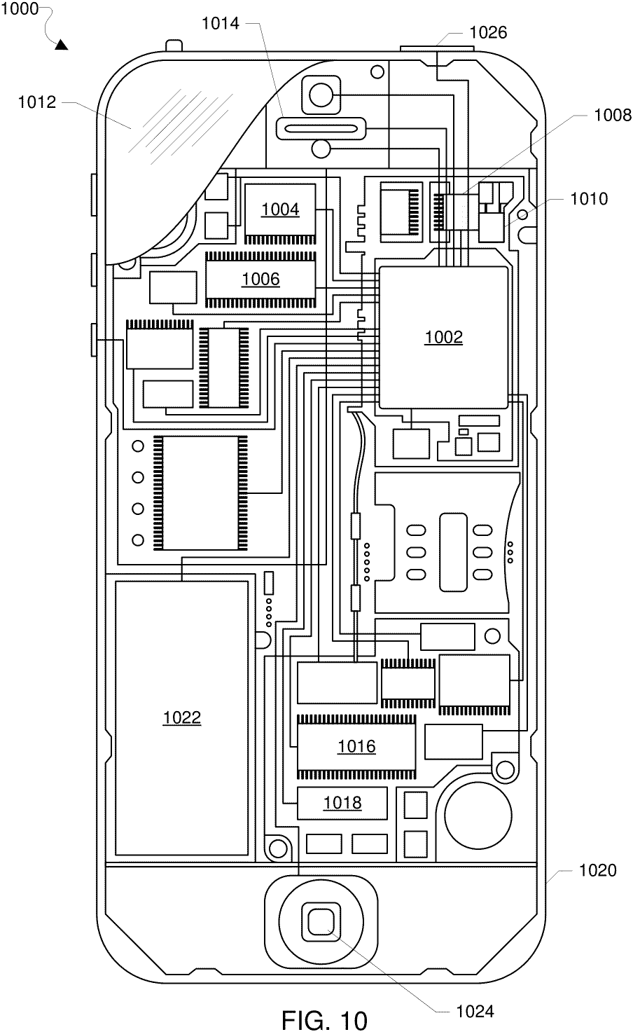

Methods and devices for implementing such methods in accordance with the various embodiments (including, but not limited to, embodiments described above with reference to FIGS. 1-9) may be implemented in a wide variety of computing systems including mobile computing devices, an example of which suitable for use with the various embodiments is illustrated in FIG. 10. The mobile computing device 1000 may include a processor 1002 coupled to a touchscreen controller 1004 and an internal memory 1006. The processor 1002 may be one or more multicore integrated circuits designated for general or specific processing tasks. The internal memory 1006 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 1004 and the processor 1002 may also be coupled to a touchscreen panel 1012, such as a resistive-sensing touchscreen, capacitive-sensing touchscreen, infrared sensing touchscreen, etc. Additionally, the display of the mobile computing device 1000 need not have touch screen capability.

The mobile computing device 1000 may have one or more radio signal transceivers 1008 (e.g., Peanut, Bluetooth, ZigBee, Wi-Fi, RF radio) and antennae 1010, for sending and receiving communications, coupled to each other and/or to the processor 1002. The transceivers 1008 and antennae 1010 may be used with the above-mentioned circuitry to implement the various wireless transmission protocol stacks and interfaces. The mobile computing device 1000 may include a cellular network wireless modem chip 1016 that enables communication via a cellular network and is coupled to the processor.

The mobile computing device 1000 may include a peripheral device connection interface 1018 coupled to the processor 1002. The peripheral device connection interface 1018 may be singularly configured to accept one type of connection, or may be configured to accept various types of physical and communication connections, common or proprietary, such as Universal Serial Bus (USB), FireWire, Thunderbolt, or PCIe. The peripheral device connection interface 1018 may also be coupled to a similarly configured peripheral device connection port (not shown).

The mobile computing device 1000 may also include speakers 1014 for providing audio outputs. The mobile computing device 1000 may also include a housing 1020, constructed of a plastic, metal, or a combination of materials, for containing all or some of the components described herein. The mobile computing device 1000 may include a power source 1022 coupled to the processor 1002, such as a disposable or rechargeable battery. The rechargeable battery may also be coupled to the peripheral device connection port to receive a charging current from a source external to the mobile computing device 1000. The mobile computing device 1000 may also include a physical button 1024 for receiving user inputs. The mobile computing device 1000 may also include a power button 1026 for turning the mobile computing device 1000 on and off.

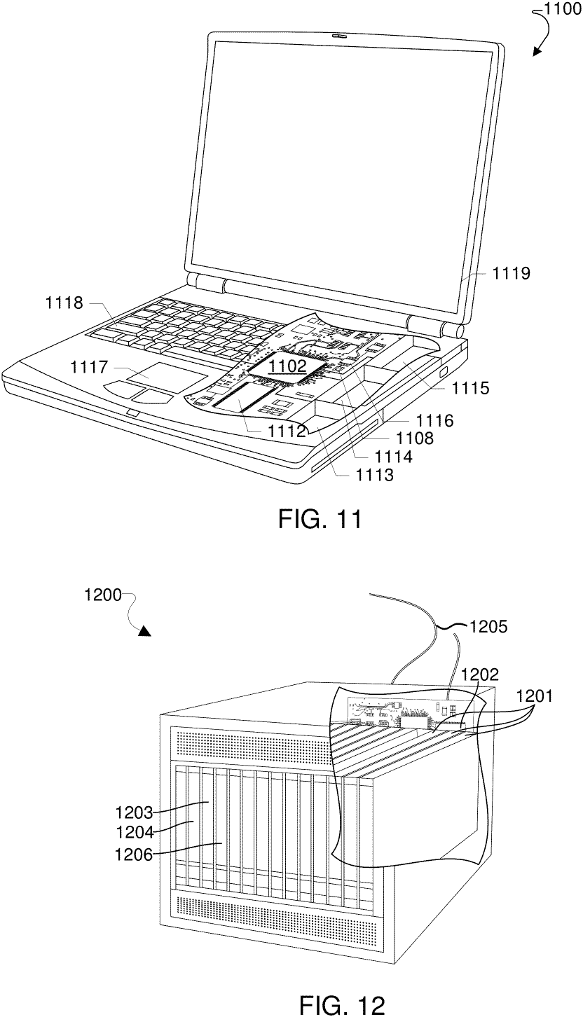

Methods and devices for implementing such methods in accordance with the various embodiments (including, but not limited to, embodiments described above with reference to FIGS. 1-9) may be implemented in a wide variety of computing systems include a laptop computer 1100 an example of which is illustrated in FIG. 11. A laptop computer 1100 will typically include a processor 1102 coupled to volatile memory 1112 and a large capacity nonvolatile memory, such as a compact disc (CD) drive 1113 or Flash memory. Additionally, the computer 1100 may have one or more antenna 1108 for sending and receiving electromagnetic radiation that may be connected to a wireless data link and/or cellular telephone transceiver 1116 coupled to the processor 1102. The computer 1100 may also include a floppy disc drive 1114 and a CD drive 1113 coupled to the processor 1112. In a notebook configuration, the computer housing may include a battery 1115, a touchpad touch surface 1117 that serves as the computer’s pointing device, a keyboard 1118, and a display 1119 all coupled to the processor 1102. Other configurations of the computing device may include a computer mouse or trackball coupled to the processor (e.g., via a USB input) as are well known, which may also be used in conjunction with the various embodiments.

Methods and devices for implementing such methods in accordance with the various embodiments (including, but not limited to, embodiments described above with reference to FIGS. 1-9) may also be implemented in fixed computing systems, such as any of a variety of commercially available servers. An example server 1200 is illustrated in FIG. 12. Such a server 1200 typically includes one or more multicore processor assemblies 1201 coupled to volatile memory 1202 and a large capacity nonvolatile memory, such as a disk drive 1204. As illustrated in FIG. 12, multicore processor assemblies 1201 may be added to the server 1200 by inserting them into the racks of the assembly. The server 1200 may also include a floppy disc drive, compact disc (CD) or digital versatile disc (DVD) disc drive 1206 coupled to the processor 1201. The server 1200 may also include network access ports 1203 coupled to the multicore processor assemblies 1201 for establishing network interface connections with a network 1205, such as a local area network coupled to other broadcast system computers and servers, the Internet, the public switched telephone network, and/or a cellular data network (e.g., CDMA, TDMA, GSM, PCS, 3G, 4G, LTE, 5G, or any other type of cellular data network).

Further details regarding various embodiments are described in Appendix A hereto, which is part of this specification disclosure as if included within the numbered paragraphs.

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method for weight layout transformation of a weight tensor, comprising:
accessing a first memory to retrieve weights of the weight tensor in a transformed order that is different than an order for retrieving the weights for a calculation at a network layer of a trained machine learning model; and
loading the weights to a second memory in the transformed order.

2. The method of claim 1, wherein accessing the first memory to retrieve weights of the weight tensor in the transformed order that is different than the order for retrieving the weights for the calculation at the network layer of the trained machine learning model comprises accessing the first memory to retrieve the weights according to a pattern of memory access iterating over a slowest changing dimension of the weight tensor.

3. The method of claim 2, wherein accessing the first memory to retrieve the weights according to the pattern of memory access iterating over the slowest changing dimension of the weight tensor comprises retrieving the weights according to a pattern of memory access iterating over a height dimension of the weight tensor.

4. The method of claim 1, wherein accessing the first memory to retrieve weights of the weight tensor in the transformed order that is different than the order for retrieving the weights for the calculation at the network layer of the trained machine learning model comprises accessing the first memory to retrieve weights of the weight tensor in an order specified by a first counter variable and a second counter variable of a first memory access command, wherein the first counter variable and the second counter variable are configured to represent a location in the weight tensor, and wherein the first counter variable and the second counter variable are transposed relative to a second memory access command having the first counter variable and the second counter variable of the network layer of the trained machine learning model.

5. The method of claim 1, wherein loading the weights to the second memory in the transformed order comprises loading the weights to the second memory in a linear layout according to a pattern of memory access iterating over a slowest changing dimension of the weight tensor.

6. The method of claim 5, wherein loading the weights to the second memory in the linear layout comprises loading the weights to the second memory as a linear array.

7. The method of claim 1, further comprising:
retrieving the weights from the second memory in the transformed order; and
reordering the weights to the order for implementing the calculation at the network layer of the trained machine learning model.

8. The method of claim 1, wherein the first memory and the second memory are in a same memory device.

9. A computing device, comprising:
a first memory;
a second memory; and
a processing device coupled to the first memory and the second memory and configured with processor-executable instructions:
access the first memory to retrieve weights of a weight tensor in a transformed order that is different than an order for retrieving the weights for a calculation at a network layer of a trained machine learning model; and
load the weights to the second memory in the transformed order.

10. The computing device of claim 9, wherein the processing device is further configured with processor-executable instructions to access the first memory to retrieve weights of the weight tensor in the transformed order that is different than the order for retrieving the weights for the calculation at the network layer of the trained machine learning model by accessing the first memory to retrieve the weights according to a pattern of memory access iterating over a slowest changing dimension of the weight tensor.

11. The computing device of claim 10, wherein the processing device is further configured with processor-executable instructions to access the first memory to retrieve the weights according to the pattern of memory access iterating over the slowest changing dimension of the weight tensor by retrieving the weights according to a pattern of memory access iterating over a height dimension of the weight tensor.

12. The computing device of claim 9, wherein the processing device is further configured with processor-executable instructions to access the first memory to retrieve weights of the weight tensor in the transformed order that is different than the order for retrieving the weights for the calculation at the network layer of the trained machine learning model by accessing the first memory to retrieve weights of the weight tensor in an order specified by a first counter variable and a second counter variable of a first memory access command, wherein the first counter variable and the second counter variable are configured to represent a location in the weight tensor, and wherein the first counter variable and the second counter variable are transposed relative to a second memory access command having the first counter variable and the second counter variable of the network layer of the trained machine learning model.

13. The computing device of claim 9, wherein the processing device is further configured with processor-executable instructions to load the weights to the second memory in the transformed order by loading the weights to the second memory in a linear layout according to a pattern of memory access iterating over a slowest changing dimension of the weight tensor.

14. The computing device of claim 13, wherein the processing device is further configured with processor-executable instructions to load the weights to the second memory in the linear layout by loading the weights to the second memory as a linear array.

15. The computing device of claim 9, wherein the processing device is further configured with processor-executable instructions to:
retrieve the weights from the second memory in the transformed order; and
reorder the weights to the order for implementing the calculation at the network layer of the trained machine learning model.

16. The computing device of claim 9, wherein the first memory and the second memory are in a same memory device.

17. A computing device, comprising:
means for accessing a first memory to retrieve weights of a weight tensor in a transformed order that is different than an order for retrieving the weights for a calculation at a network layer of a trained machine learning model; and
means for loading the weights to a second memory in the transformed order.

18. A non-transitory, processor-readable medium having stored thereon processor-executable instructions configured to cause a processor of a computing device to perform operations comprising:
accessing a first memory to retrieve weights of a weight tensor in a transformed order that is different than an order for retrieving the weights for a calculation at a network layer of a trained machine learning model; and
loading the weights to a second memory in the transformed order.

19. The non-transitory, processor-readable medium of claim 18, wherein the processor-executable instructions are configured to cause the processor of the computing device to perform operations such that accessing the first memory to retrieve weights of the weight tensor in the transformed order that is different than the order for retrieving the weights for the calculation at the network layer of the trained machine learning model comprises accessing the first memory to retrieve the weights according to a pattern of memory access iterating over a slowest changing dimension of the weight tensor.

20. The non-transitory, processor-readable medium of claim 19, wherein the processor-executable instructions are configured to cause the processor of the computing device to perform operations such that accessing the first memory to retrieve the weights according to the pattern of memory access iterating over the slowest changing dimension of the weight tensor comprises retrieving the weights according to a pattern of memory access iterating over a height dimension of the weight tensor.

21. The non-transitory, processor-readable medium of claim 18, wherein the processor-executable instructions are configured to cause the processor of the computing device to perform operations such that accessing the first memory to retrieve weights of the weight tensor in the transformed order that is different than the order for retrieving the weights for the calculation at the network layer of the trained machine learning model comprises accessing the first memory to retrieve weights of the weight tensor in an order specified by a first counter variable and a second counter variable of a first memory access command, wherein the first counter variable and the second counter variable are configured to represent a location in the weight tensor, and wherein the first counter variable and the second counter variable are transposed relative to a second memory access command having the first counter variable and the second counter variable of the network layer of the trained machine learning model.

22. The non-transitory, processor-readable medium of claim 18, wherein the processor-executable instructions are configured to cause the processor of the computing device to perform operations such that loading the weights to the second memory in the transformed order comprises loading the weights to the second memory in a linear layout according to a pattern of memory access iterating over a slowest changing dimension of the weight tensor.

23. The non-transitory, processor-readable medium of claim 22, wherein the processor-executable instructions are configured to cause the processor of the computing device to perform operations such that loading the weights to the second memory in the linear layout comprises loading the weights to the second memory as a linear array.

24. The non-transitory, processor-readable medium of claim 18, wherein the processor-executable instructions are configured to cause the processor of the computing device to perform operations further comprising:
retrieving the weights from the second memory in the transformed order; and
reordering the weights to the order for implementing the calculation at the network layer of the trained machine learning model.

25. The non-transitory, processor-readable medium of claim 18, wherein the processor-executable instructions are configured to cause the processor of the computing device to perform operations such that the second memory is the first memory.
